(19) United States
(12) Patent Application Publication
(10) Pub. No.: US 2019/0288427 A1
(43) Pub. Date: Sep. 19, 2019

(54) Connection Terminal

(71) Applicant: Tyco Electronics (Shanghai) Co. Ltd., Shanghai (CN)

(72) Inventors: Lei Pan, Shanghai (CN); Pai Rajendra, Bangalore (IN); Tongbao Ding, Shanghai (CN); Huigang Guo, Shanghai (CN); Xing Tong, Shanghai (CN)

(73) Assignee: Tyco Electronics (Shanghai) Co. Ltd., Shanghai (CN)

(21) Appl. No.: 16/299,768

(22) Filed: Mar. 12, 2019

(30) Foreign Application Priority Data
Mar. 13, 2018 (CN) 201820340362.9

(51) Int. Cl. H01R 13/20; H01R 13/115; H01R 4/18

(52) U.S. Cl. CPC H01R 13/20; H01R 4/185; H01R 13/115

(57) ABSTRACT

A connection terminal comprises a receptacle part, a crimping part, and a connection part connected between the receptacle part and the crimping part. The crimping part includes a conductor crimping part adapted to be crimped on a conductor of a wire and an outer layer crimping part adapted to be crimped on an outer layer of the wire. The conductor crimping part includes a first conductor crimping part and a second conductor crimping part which are spaced from each other by an interval in a lateral direction perpendicular to the longitudinal direction. The receptacle part includes an elastic latch adapted to lock a plug inserted into the receptacle part and located at a rear end of the receptacle part close to the crimping part. The elastic latch is positioned between the first conductor crimping part and the second conductor crimping part in the lateral direction.

### CROSS-REFERENCE TO RELATED APPLICATION

This application claims the benefit of the filing date under 35 U.S.C. § 119(a)-(d) of Chinese Patent Application No. 201820340362.9, filed on Mar. 13, 2018.

### FIELD OF THE INVENTION

The present invention relates to a connection terminal and, more particularly, to a connection terminal having a receptacle part and a crimping part.

### BACKGROUND

A connection terminal generally includes a receptacle part located at a first end of the connection terminal in a longitudinal direction, a crimping part located at a second end of the connection terminal in the longitudinal direction, and a connection part connected between the receptacle part and the crimping part. The receptacle part is adapted to mate with a plug so as to be electrically connected therewith. The crimping part is adapted to be crimped on a wire so as to be electrically connected therewith. The crimping part generally includes a conductor crimping part adapted to be crimped on a conductor of the wire and an outer layer crimping part adapted to be crimped on an outer layer of the wire. The receptacle part generally includes an elastic latch adapted to lock the plug inserted into the receptacle part and located at a rear end of the receptacle part.

The conductor crimping part of the crimping part is generally arranged outside of the receptacle part in a lateral direction so as to be staggered with the elastic latch, thereby preventing the conductor crimping part from interfering with the elastic latch. Such a design does not increase a longitudinal dimension of the connection terminal, but increases a lateral dimension of the connection terminal, which is detrimental to miniaturization of the connection terminal.

### SUMMARY

A connection terminal comprises a receptacle part, a crimping part, and a connection part connected between the receptacle part and the crimping part. The crimping part includes a conductor crimping part adapted to be crimped on a conductor of a wire and an outer layer crimping part adapted to be crimped on an outer layer of the wire. The conductor crimping part includes a first conductor crimping part and a second conductor crimping part which are spaced from each other by an interval in a lateral direction perpendicular to the longitudinal direction. The receptacle part includes an elastic latch adapted to lock a plug inserted into the receptacle part and located at a rear end of the receptacle part close to the crimping part. The elastic latch is positioned between the first conductor crimping part and the second conductor crimping part in the lateral direction.

### BRIEF DESCRIPTION OF THE DRAWINGS

The invention will now be described by way of example with reference to the accompanying Figures, of which:

FIG. 1 is a perspective view of a connection terminal according to an embodiment.

### DETAILED DESCRIPTION OF THE EMBODIMENT(S)

The technical solution of the present disclosure will be described hereinafter in further detail with reference to the following embodiments, taken in conjunction with the accompanying drawings. In the specification, the same or similar reference numerals indicate the same or similar parts. The description of the embodiments of the present disclosure hereinafter with reference to the accompanying drawings is intended to explain the general inventive concept of the present disclosure, and should not be constructed as a limitation to the present disclosure.

In addition, in the following detailed description, for the sake of explanation, numerous specific details are set forth in order to provide a thorough understanding of the disclosed embodiments. It will be apparent, however, one or more embodiments may also be practiced without these specific details. In other instances, well-known structures and devices are illustrated schematically in order to simplify the drawing.

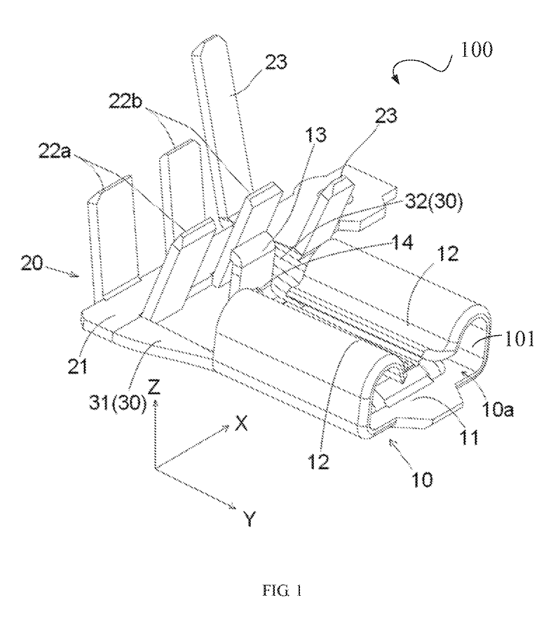

A connection terminal 100 according to an embodiment, as shown in FIG. 1, comprises a receptacle part 10, a crimping part 20, and a connection part 30. The receptacle part 10 is disposed at a first end of the connection terminal 100 in a longitudinal direction Y and configured to mate with a plug inserted into the receptacle part 10. The crimping part 20 is disposed at a second end of the connection terminal 100 in the longitudinal direction Y opposite the first end and configured to be crimped on a wire. The connection part 30 is connected between the receptacle part 10 and the crimping part 20. In an embodiment, the connection terminal 100 is an integrated piece formed of a single metal sheet, for example, a copper sheet.

The crimping part 20, as shown in FIG. 1, includes a conductor crimping part adapted to be crimped on a conductor of the wire and an outer layer crimping part 23 adapted to be crimped on an outer layer of the wire. The receptacle part 10 includes an elastic latch 13 adapted to lock the plug inserted into the receptacle part 10 and located at a rear end of the receptacle part 10 close to the crimping part 20.

As shown in FIG. 1, the conductor crimping part includes a first conductor crimping part 22a and a second conductor crimping part 22b which are spaced from each other by an interval in a lateral direction X perpendicular to the longitudinal direction Y. The elastic latch 13 is positioned between the first conductor crimping part 22a and the second conductor crimping part 22b; a projection of the elastic latch 13 in the longitudinal direction Y is positioned in the interval between the first conductor crimping part 22a and the second conductor crimping part 22b. The elastic latch 13 is thereby prevented from interfering with the conductor crimping part during forming them, and also does not increase both the longitudinal and lateral dimensions of the connection terminal 100, which is beneficial to the miniaturization of the connection terminal 100.

The crimping part 20, as shown in FIG. 1, includes a base 21 extending in the lateral direction X. The base 21 connects the first conductor crimping part 22a, the second conductor crimping part 22b, and the outer layer crimping part 23. The base 21 has a pair of opposite sides in the longitudinal direction Y. The first conductor crimping part 22a includes a pair of first conductor crimping wings located on the two opposite sides of the base 21. The second conductor crimping part 22b includes a pair of second conductor crimping wings located on the two opposite sides of the base 21. The outer layer crimping part 23 includes a pair of outer layer crimping wings located on the two opposite sides of the base 21.

As shown in FIG. 1, the connection part 30 includes a first connection part 31 and a second connection part 32 which are arranged at a pair of opposite sides of the receptacle part 10 in the lateral direction X. The first conductor crimping part 22a, the second conductor crimping part 22b, and the elastic latch 13 are positioned between the first connection part 31 and the second connection part 32 in the lateral direction X. The second connection part 32 is positioned between the second conductor crimping part 22b and the outer layer crimping part 23 in the lateral direction X.

The first connection part 31 has a front end and a rear end which are opposed to each other in the longitudinal direction Y, and the second connection part 32 has a front end and a rear end which are opposed to each other in the longitudinal direction Y. In the embodiment shown in FIG. 1, the rear end of the first connection part 31 is connected to a first position of the base 21 adjacent to the first conductor crimping part 22a, and the front end of the first connection part 31 is connected to the rear end of the receptacle part 10. The rear end of the second connection part 32 is connected to a second position of the base 21 adjacent to the second conductor crimping part 22b, and the front end of the second connection part 32 is connected to the rear end of the receptacle part 10.

The receptacle part 10, as shown in FIG. 1, includes a bottom 11 and a pair of elastic contact parts 12. An insert cavity 10a is formed between the bottom 11 and the elastic contact parts 12 to receive the plug inserted into the receptacle part 10. The elastic contact parts 12 are adapted to elastically electrically contact the plug inserted into the receptacle part 10. The bottom 11 has a left side and a right side which are opposed to each other in the lateral direction X. The bottom 11 further has a front end and a rear end which are opposed to each other in the longitudinal direction Y. The pair of elastic contact parts 12 are connected to the left side and the right side of the bottom 11, respectively. The elastic latch 13 is connected to the rear end of the bottom 11. The insert cavity 10a has a front opening 101 located at the front end of the bottom 11, so that the plug is adapted to be inserted into the insert cavity 10a in the longitudinal direction Y from the front opening 101.

As shown in FIG. 1, the front end of the first connection part 31 is connected to one of the left side and the right side of the bottom 11, and the front end of the second connection part 32 is connected to the other one of the left side and the right side of the bottom 11. The first connection part 31 and the second connection part 32 both flatly extend from the crimping part 20 to the receptacle part 10 in the longitudinal direction Y.

In the embodiment shown in FIG. 1, each of the elastic contact parts 12 is an elastic contact piece that is crimped into an arc shape. The elastic contact piece is adapted to elastically electrically contact with a top surface of the plug inserted into the receptacle part 10.

As shown in FIG. 1, an elastic lock 14 projecting towards an inner portion of the insert cavity 10a is formed on the elastic latch 13. The elastic lock 14 is adapted to latch into a recess on a front end surface of the plug inserted into the receptacle part 10.

It should be appreciated for those skilled in this art that the above embodiments are intended to be illustrative, modifications may be made to the above embodiments by those skilled in the art, and structures described in various embodiments may be freely combined without having structural and principle conflict, so that more conductive terminals and connector assemblies will be achieved on the basis of solving the technical problem of the present disclosure. Although some embodiments of the general concept of the present disclosure have been shown and described, it would be appreciated by those skilled in the art that modifications may be made to these embodiments without departing from the principle and spirit of the present disclosure, the scope of which is defined in the claims and their equivalents.

What is claimed is:

1. A connection terminal, comprising:
a receptacle part disposed at a first end of the connection terminal in a longitudinal direction and configured to mate with a plug inserted into the receptacle part;
a crimping part disposed at a second end of the connection terminal in the longitudinal direction and configured to be crimped on a wire, the crimping part includes a conductor crimping part adapted to be crimped on a conductor of the wire and an outer layer crimping part adapted to be crimped on an outer layer of the wire, the conductor crimping part includes a first conductor crimping part and a second conductor crimping part which are spaced from each other by an interval in a lateral direction perpendicular to the longitudinal direction; and
a connection part connected between the receptacle part and the crimping part, the receptacle part includes an elastic latch adapted to lock the plug inserted into the receptacle part and located at a rear end of the receptacle part close to the crimping part, the elastic latch is positioned between the first conductor crimping part and the second conductor crimping part in the lateral direction.

2. The connection terminal of claim 1, wherein the connection part includes a first connection part and a second connection part which are arranged at a pair of opposite sides of the receptacle part in the lateral direction.

3. The connection terminal of claim 2, wherein the first conductor crimping part, the second conductor crimping part, and the elastic latch are positioned between the first connection part and the second connection part in the lateral direction.

4. The connection terminal of claim 3, wherein the second connection part is positioned between the second conductor crimping part and the outer layer crimping part in the lateral direction.

5. The connection terminal of claim 4, wherein the crimping part includes a base extending in the lateral direction, the base connecting the first conductor crimping part, the second conductor crimping part, and the outer layer crimping part.

6. The connection terminal of claim 5, wherein the first connection part has a front end and a rear end which are opposite to each other in the longitudinal direction and the second connection part has a front end and a rear end which are opposite to each other in the longitudinal direction.

7. The connection terminal of claim 6, wherein the rear end of the first connection part is connected to a first position of the base adjacent to the first conductor crimping part and the front end of the first connection part is connected to the rear end of the receptacle part.

8. The connection terminal of claim 7, wherein the rear end of the second connection part is connected to a second position of the base adjacent to the second conductor crimping part and the front end of the second connection part is connected to the rear end of the receptacle part.

9. The connection terminal of claim 8, wherein the base has a pair of opposite sides in the longitudinal direction, the first conductor crimping part has a pair of first conductor crimping wings located on the opposite sides of the base, the second conductor crimping part has a pair of second conductor crimping wings located on the opposite sides of the base, and the outer layer crimping part has a pair of outer layer crimping wings located on the opposite sides of the base.

10. The connection terminal of claim 9, wherein the receptacle part includes a bottom and a pair of elastic contact parts, an insert cavity is formed between the bottom and the elastic contact parts to receive the plug inserted into the receptacle part.

11. The connection terminal of claim 10, wherein the elastic contact parts are adapted to elastically electrically contact with the plug inserted into the receptacle part.

12. The connection terminal of claim 11, wherein the bottom has a left side and a right side which are opposite to each other in the lateral direction, and the bottom has a front end and a rear end which are opposite to each other in the longitudinal direction.

13. The connection terminal of claim 12, wherein the pair of elastic contact parts are respectively connected to the left side and the right side of the bottom, and the elastic latch is connected to the rear end of the bottom.

14. The connection terminal of claim 13, wherein the insert cavity has a front opening located at the front end of the bottom, the plug is adapted to be inserted into the insert cavity in the longitudinal direction from the front opening.

15. The connection terminal of claim 14, wherein each of the elastic contact parts is an elastic contact piece that is crimped into an arc shape and adapted to elastically electrically contact with a top surface of the plug inserted into the receptacle part.

16. The connection terminal of claim 14, wherein an elastic lock projecting towards an inner portion of the insert cavity is formed on the elastic latch, the elastic lock is adapted to latch into a recess on a front end surface of the plug inserted into the receptacle part.

17. The connection terminal of claim 14, wherein the front end of the first connection part is connected to one of the left side and the right side of the bottom, and the front end of the second connection part is connected to the other one of the left side and the right side of the bottom.

18. The connection terminal of claim 3, wherein the first connection part and the second connection part both flatly extend from the crimping part to the receptacle part in the longitudinal direction.

19. The connection terminal of claim 1, wherein the connection terminal is an integrated piece formed of a single metal sheet.
